(19) United States
(12) Patent Application Publication
(10) Pub. No.: US 2015/0176821 A1
(43) Pub. Date: Jun. 25, 2015

(54) Fastening Device for a Lamp

(71) Applicant: PAULMANN LICHT GMBH, Spring-Volksen (DE)

(72) Inventors: Matthias Vogt, Springe-Volksen (DE); Gerald Giese, Springe-Volksen (DE); Caroline Gonschorek, Springe-Volksen (DE); Frank Sprick, Springe-Volksen (DE); Detlev Paulmann, Springe-Volksen (DE)

(73) Assignee: PAULMANN LICHT GMBH, Springe-Volksen (DE)

(21) Appl. No.: 14/378,142

(22) PCT Filed: Feb. 13, 2013
(86) PCT No.: PCT/EP2013/052901

§ 371 Date: Mar. 10, 2015

(30) Foreign Application Priority Data
Feb. 13, 2012 (DE) 202012001343.2

(51) Int. Cl. F21V 21/008; F21V 23/00; F21V 21/29; F21S 8/04

(52) U.S. Cl. CPC F21V 21/008; F21S 8/046; F21V 23/001; F21V 21/29; F21Y 2101/02

(57) ABSTRACT

A fastening device is described for at least one lighting means, comprising at least one rope and at least one carrier embodied for fastening at least one lighting means, comprising at least one fastening means for fastening at the ropes and connection means for connecting at least one lighting means to at least one electric supply line. The particular feature of the invention is the fact that at least one rope comprises at least one ultra-strong fiber or is made from at least one ultra-strong fiber.

The invention relates to a fastening device for at least one lighting means, comprising at least one rope and at least one carrier for fastening at least one lighting means, which carrier comprises at least one fastening means for fastening at the ropes and connection means for connecting at least one lamp to at least one electric supply line. Further, the invention also relates to a lamp comprising such a fastening device.

Fastening devices of the type mentioned at the outset are used in practice in a plurality of forms, with the ropes provided for this purpose usually not being used for the direct suspension of a lamp in the vertical alignment, but in a space between two points, particularly between two opposite walls of the room, arranged in an alignment angled in reference to the plumb line, preferably arranged and stretched in an alignment, for example an approximately horizontal one.

Due to the fact that the carriers are fastened at ropes, said ropes essentially compensate the entire load generated by the weight of the carriers and the lamps fastened thereat. Thus, the entire system is essentially suspended by the ropes, with the electric supply lines perhaps playing an additional supportive role, depending on their embodiment. In order to meet their supportive function securely and reliably and to exclude any risk of the ropes tearing they are to be sized appropriately in their diameter. Here, the breaking load increases with larger diameters of a rope. For the sizing it must be observed that at least all permitted load cases are covered. Since the load generated by the overall weight of the carriers and the lamps fastened thereat is aligned vertically due to gravity, however commonly the ropes are aligned approximately horizontally, a load develops in the ropes, which is equivalent to a multiple of the load generated by the weight of the carriers and the lamps. This circumstance, which by the way can be confirmed by simple force—vector calculation, also leads to an extended stretching of the ropes; in order to largely avoid such a stretching the ropes shall already be appropriately sized in their diameters. Here, not only the static loads are to be considered but additionally also the dynamic loads, which can occur for example during the assembly or in the assembled state by inappropriate contact or due to oscillating motions caused by air drafts. The dynamic load peaks are additionally amplified multiple times in the ropes due to their approximately horizontal alignment, by which any dynamic stress is extremely noticeable. Last but not least due to the risk that such dynamic load can occur additionally, here when sizing the diameter of the ropes sufficient distance must be also considered until the breaking load is reached, thus sufficient safety reserve must be given. In particular due to the high overall weight, in a complex system with a plurality of carriers and lamps, here ropes with a relatively large diameter are necessary. Depending on the location and purpose for use however, particularly thick ropes may be disadvantageous for various reasons, and thus undesired. In particular such ropes can be visually disturbing and thus negatively influence the appearance of the entire system.

Therefore the objective of the present invention is to improve a fastening device of the type mentioned at the outset such the above-described disadvantages are avoided.

This objective is attained in a fastening device for at least one lamp, comprising at least one rope and at least one carrier embodied for fastening at least one lighting means, showing at least one fastening means for fastening at the ropes and connection means for connecting at least one lighting means to at least one electric supply line, characterized in that at least one rope shows at least one ultra-strong fiber or is made from at least one ultra-strong fiber.

The invention is based on the idea to use ultra-strong fiber material for the rope instead of conventional fiber material, which previously has been used for special applications in industrial fields, such as in airplane or vehicle construction. Here the invention utilizes the acknowledgement that in a given diameter ultra-strong fibers show a considerably higher breaking load than conventional fibers, allowing to realize distinctly smaller diameters for a given breaking load. Ropes with smaller diameters show no disturbing effect upon the appearance of the overall system. Additionally, ultra-strong fibers show distinctly less stretching than conventional fibers; the stretching behavior of most ultra-strong fibers is approximately equivalent to the stretching behavior of steel ropes. This circumstance also shows advantages for a system of lamps and ropes, in which the weight caused by the carriers and the lamps must be compensated essentially by the horizontally arranged ropes. Accordingly, with the use of the invention it is possible for the first time to provide a filigree rope system, which still shows the required support load, though. Depending on the embodiment and purpose for use here the rope can be embodied so thin that practically it is no longer visually recognized. Furthermore, when using the construction according to the invention additional supportive measures for compensating loads can be waived, such as the use of electric supply lines, so that the ropes can represent the sole support elements.

Preferably, at least one ultra-strong fiber comprises glass, carbon, aramid, or high-strength polyethylene, particularly highly crystalline, highly stretched, ultra-high molecular polyethylene.

The use of an ultra-strong fiber according to the invention can be considered for a fastening device for at least one lighting means or one lamp, which comprises only a single rope, generally showing an angle in reference to the plumb line, particularly aligned approximately horizontally, with the carrier being provided with only one fastening means for fastening at the rope. Accordingly, the present invention also covers in general a fastening device comprising a single rope and at least one carrier embodied for fastening at least one lamp, which shows a fastening means for fastening at the rope and connection means for connecting at least one lighting means to at least one electric supply line.

In the alternative case of using at least two ropes, distanced from each other and showing an angle in reference to the plumb line, particularly aligned approximately horizontally, and the embodiment of the carrier with at least two fastening means, distanced from each other, in the following preferred embodiments are disclosed, in which the ropes are preferably made from ultra-strong fibers, which is however not mandatory, and which therefore form additional, independent aspects of the invention.

For example, the carrier may show preferably at least two arms, respectively provided with a fastening means or forming a fastening means. The embodiment with the arms is advantageous, among other things, in that it is supported resting with the arms on the separated ropes, positioned approximately in a horizontal alignment. In a further development the arms are approximately aligned towards each other and/or the carrier with the arms can be arranged essentially perpendicular in reference to the longitudinal extension of the ropes.

In another particularly preferred embodiment the carrier shows an annular section, which is provided for fastening at least one lighting means. Such an annular section can be used not only for installing in a particularly secure way at least one lighting means in a standing or suspended fashion, but it can also serve advantageously as a frame for a lighting means, for example, by arranging the lighting means inside this annular section and it being fastened thereat. Preferably the above-mentioned arms can be arranged radially at the annular section.

In particular when the lighting means is arranged at the annular section in a torque-proof fashion it is advantageous to rotationally support the annular section, in order to allow for a better adjustment of the lighting means to the respective purpose for use with regards to its direction of illumination. Preferably the pivotal axis for such a pivotal bearing may be essentially aligned to at least one of the arms.

In another preferred embodiment the carrier comprises bearing means, which are embodied for fastening at least one lamp inside the annular section. In a further development of this embodiment the bearing means may be embodied for the support of at least one lamp, pivotal about a pivotal axis, which is positioned approximately in a level stretched by the annular section. This embodiment therefore shows no torque proof and/or spatially fixed arrangement in reference to the annular section, but a rotational support of a lamp in reference to the annular section so that the annular section itself can be arranged fixed at its location.

Alternatively the annular section may also be provided with means for suspending at least one lamp. In a preferred further development of this embodiment the means for suspension may show two fittings arranged at the annular section, which are located approximately diametrically opposite each other and are embodied for the fastening of at least one fastening element, carrying a lamp and being embodied oblong, preferably rod-shaped or rope shaped.

Furthermore, alternatively a series of lighting means, preferably light diodes, may be arranged along the annular section, preferably along its interior and/or exterior, with in such a case the annular section of the carrier with the lighting means arranged serially thereat forming a structural unit, which can be defined as an annular lamp.

In another preferred embodiment the carriers are provided with fastening elements to fasten the electric supply lines. This way the option for fixing the electric supply lines is provided, without here additional fasteners or the like outside the carriers being necessary. Beneficially the fastening elements may include electric connecting means in order to generate in an elegantly designed fashion an option for an electric connection to the lamp fastened at the carrier. Alternatively it is also possible to embody those fastening elements only for a mechanic fixation of the electric supply lines and additionally provide small connection cables or strips, which preferably connect the lamp to the electric supply lines ‘in an over-hung fashion’. For an optimal arrangement preferably the fastening means should be provided at the annular section and be located approximately diametrically opposite each other. A preferred design is characterized in that the fastening means show sheaths, approximately radially projecting from the fastening means, for accepting one end of an electric supply line.

A preferred, visually appealing and space-saving arrangement of the carrier with its annular section can be particularly achieved such that the annular section with the level stretched by it is arranged parallel to a level stretched by the ropes, generally approximately aligned horizontally.

The carrier and particularly its above-mentioned annular section can be preferably produced from rod-shaped parts and particularly wires, resulting not only in a particularly stiff and long-lasting design structure, but the desired filigree appearance of the overall system is advantageously supported.

In the following, preferred exemplary embodiments of the invention are explained in greater detail based on the attached drawings. It shows:

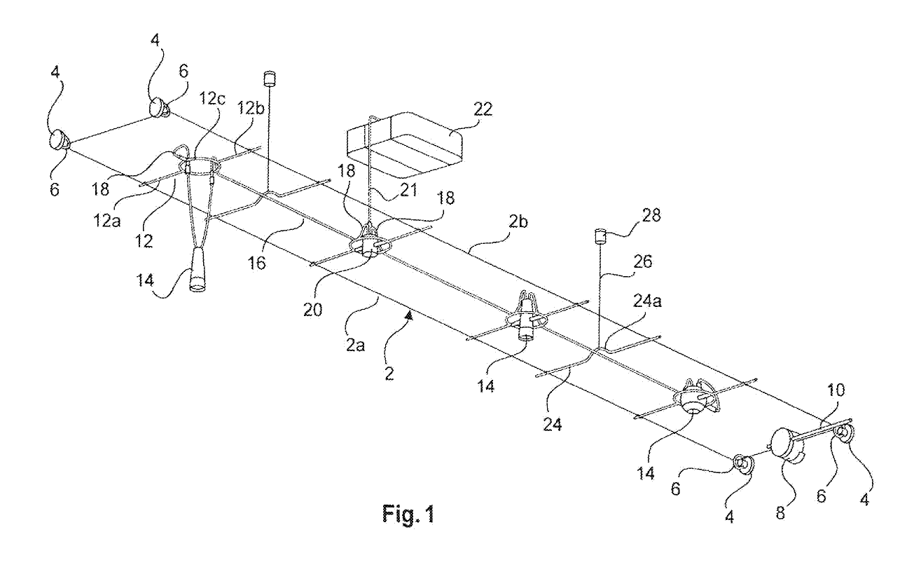

FIG. 1 in a perspective view, schematically a preferred embodiment of the fastening device according to the invention, which is embodied as a two-part fastening rope system;

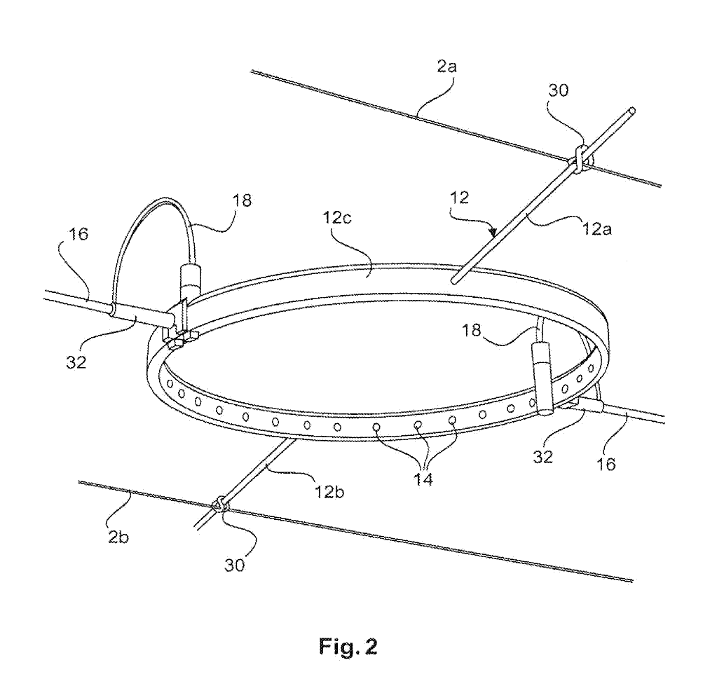

FIG. 2 in a perspective detail, schematically a carrier with an annular section and light diodes, serially fastened thereat, according to a first preferred embodiment;

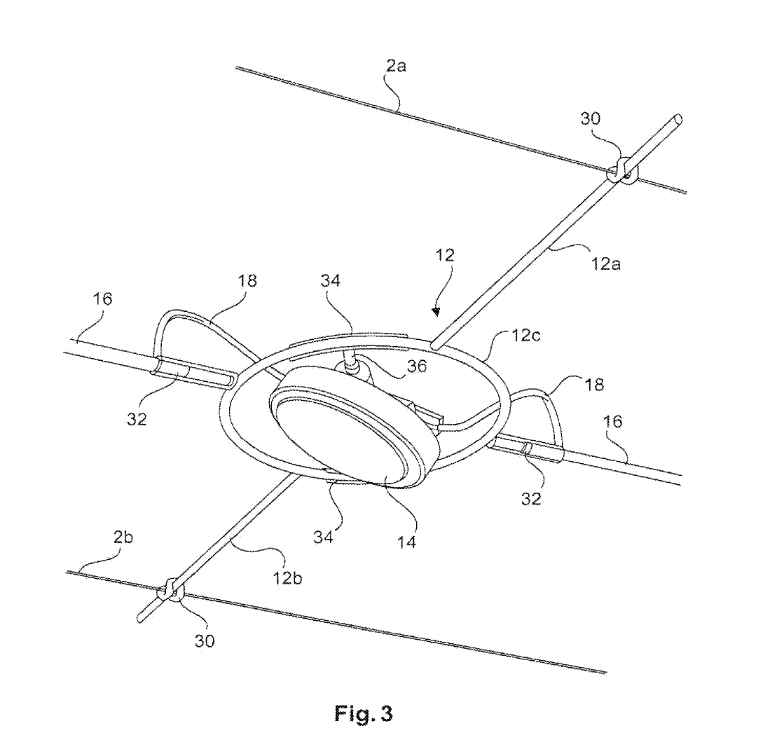

FIG. 3 in a perspective detail, schematically a carrier with a lamp fastened thereat according to a second preferred embodiment; and

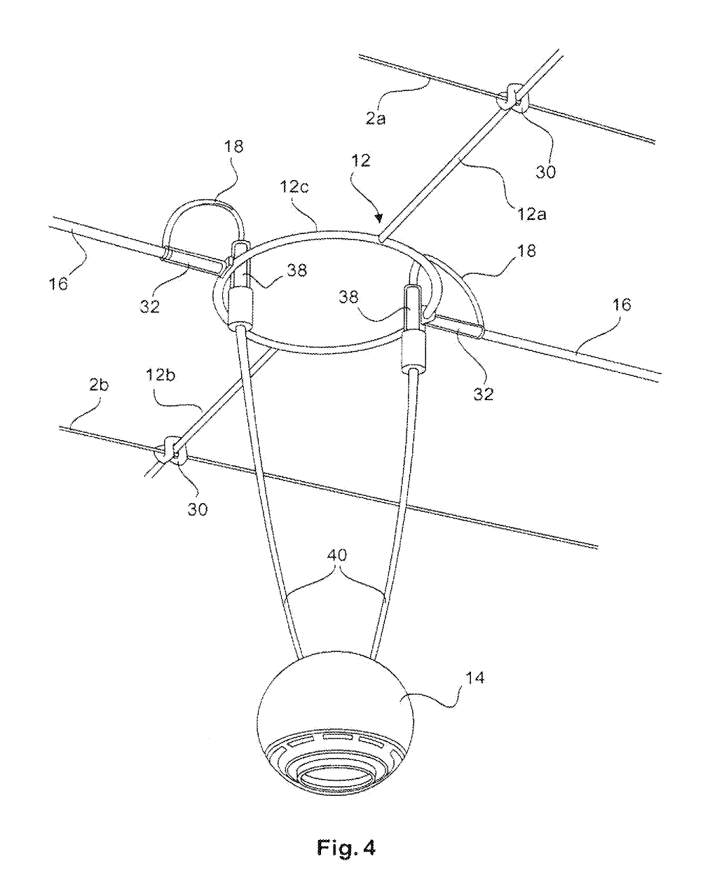

FIG. 4 in a perspective view, schematically a carrier with a lamp suspended thereat according to a third preferred embodiment.

FIG. 1 shows as an example an embodiment of a fastening device, which comprises a rope 2. Fittings 4 are provided to fasten the rope 2, which preferably can be fastened at an approximately vertical element, angled in reference to the horizontal line. In general, the fastening of the fittings 4 occurs at the walls of the room. In the exemplary embodiment illustrated the two fittings 4 shown at the left in FIG. 1 are fastened at a left wall of the room, not shown in the figures, and the two fittings 6, displayed at the right in FIG. 1, at an opposite right wall of the room, not shown in the figures, either. The fittings 4 are each provided with an eyelet 6, with the rope 2 being guided through it. In the exemplary embodiment shown the fittings 4 are arranged such that the rope 2 is guided in a rectangle, with its narrow sides being defined between the two fittings 4, respectively fastened at a wall of the room, and its long sides being defined by the distance between the two pairs of fittings 4 respectively fastened at a wall of the room and thus generally by a distance between two opposite walls of the room. Accordingly the long sides are formed by two opposite rope sections and/or rope shafts 2a and 2b, which extend approximately parallel in reference to each other in the exemplary embodiment shown. Due to the fact that, as explained in greater detail in the following, the two rope sections and/or rope shafts 2a, 2b serve as the actual support ropes and thus essentially perform the carrying function for the entire system, in the embodiment shown in FIG. 1 the fastening device represents a two-part fastening rope system, in which alternatively, instead of the two rope sections and/or rope shafts 2a, 2b of a continuous rope 2, here also two separate support ropes may be provided.

In the exemplary embodiment of FIG. 1, further a tensioning device 8 is provided, which is arranged at one of the two narrow sides of the rope 2 between two adjacent fittings 4 and is fastened at a wall of the room, not shown. As further discernible from FIG. 1, the rope 2 is guided with its two ends in the tensioning device 8 and the tensioning device 8 shows a tension lever 10, with its operation ensuring that the rope 2 with its two ends is pulled into the tensioning device 8 and thus the entire rope 2 is tightened. The tightening shall largely prevent that the rope 2 sags under loads.

As further discernible from FIG. 1, by the rectangular shape of the rope 2 and particularly by the two oblong rope sections and/or rope shafts 2a, 2b a level is stretched, which in the exemplary embodiment is aligned approximately horizontally. Accordingly, in the exemplary embodiment shown, the two rope sections and/or rope shafts 2a, 2b extend approximately in the horizontal direction. In general, it is also possible to align such a rope arrangement in an inclined fashion.

As further discernible from FIG. 1, several carriers 12 are provided, with only the left carrier being marked with a reference character in FIG. 1. The carrier 12 shows a first arm 12a and a second arm 12b, aligned thereto, as well as an annular section 12c located between these two arms 12a, 12b. The two arms 12a, 12b serve to support the carrier 12 on the two rope sections and/or rope shafts 2a, 2b so that the carrier 12 with the arms 12a, 12b rests on the two rope sections and/or rope shafts 2a, 2b. The carrier 12 serves for fastening a lamp 14, which in the exemplary embodiment is fastened at the annular section 12c of the carrier 12 or inside the annular section 12c.

The lamps 14 are supplied with electricity via an electric supply line, to which the lamps 14 are connected via a freely suspended connection cable 18.

As further discernible from FIG. 1, one of the carriers 12 shown is not provided for the assembly of a lamp but for fastening a connection adapter 20, which is connected on the one side via freely suspended connection cables 18 to the electric supply lines 16 and on the other side via an electric connection line 21 to a power supply device 22. In the exemplary embodiment shown according to FIG. 1 the power supply device 22 is fastened at a ceiling, not shown, above the fastening rope system, essentially guiding the electric connection line 21 from the power supply device 22 vertically downwards to the connection adapter 20 located underneath.

As already briefly discussed, the two rope sections and/or rope shafts 2a, 2b serve as the carriers and supports for the carriers 12 and the lamps 14 fastened thereat. Thus, the rope 2 and particularly its sections and/or shafts 2a, 2b compensate essentially the entire load, which is primarily generated by the weight of the carriers 12 and the lamps 14 fastened thereat. Contrary thereto, the electric supply lines 16 essentially perform no carrying function. Since the load generated by the overall weight of the carriers 12 and the lamps 14 points vertically downwards due to gravity, however the rope sections and/or rope shafts 2a, 2b accepting the function of carrying ropes are aligned approximately horizontally in the exemplary embodiment shown, the rope 2 shows a load, which amounts to a multiple of the load generated by the weight of the carriers 12 and the lamps 14. This circumstance, which for the rest can be confirmed by a simple force—vector calculation, bears the risk of increased stretching in the rope 2 and particularly in its sections and/or shafts 2a, 2b. Here, not only the static loads, but additionally the dynamic loads shall not be ignored, which for example can occur during the assembly or in the assembled state by inappropriate contact or due to oscillating motions caused by air drafts. Additionally, the dynamic load peaks are particularly amplified by a multiple, specifically in the rope sections and/or rope shafts 2a, 2b due to their horizontal alignment, rendering any dynamic stress to be extremely noticeable.

In the exemplary embodiment discussed, the rope 2 is produced from ultra-strong fiber material, which represents preferably glass, carbon, aramid (also known under the trademark “Kevlar”), or ultra-strong polyethylene, particularly highly crystalline, highly stretched macromolecular polyethylene (also known under the trademarks “Spectra” and “Dyneema”). Such ultra-strong fibers show a considerably higher breaking load than conventional fibers at given diameters, allowing to realize considerably smaller rope diameters at given breaking loads. Additionally such ultra-strong fibers show considerably less strain than conventional fibers, because the stretching behavior of most of these ultra-strong fibers is approximately equivalent to the strain behavior of steel ropes. Using the ultra-strong fiber material for the production of the rope 2 allows therefore to provide the fastening rope system shown with a filigree appearance, which however still shows the required support load and little strain. Here, with the help of the ultra-strong fiber material used it is easily possible during the sizing of the diameter of the rope to consider sufficient safety reserves without the diameter becoming noticeably large.

Even when by the use of ultra-strong fiber material for the rope 2 in general additional supportive measures can be waived for compensating the load, FIG. 1 shows as an example two rod-shaped support elements 24, which are aligned horizontally and support the two rope sections and/or rope shafts 2a, 2b distanced from each other. Among the two support elements shown in FIG. 2, only the right support element is marked with the reference character. The rope 2 therefore rests with its two sections and/or shafts 2a, 2b on the support elements 24. In order to prevent colliding with the electric supply lines 16 extending between the two rope sections and/or rope shafts 2a, 2b, the central section 24a of the rod-shaped support elements 24 is curved upwards. Simultaneously this curved central section 24a of the support elements 24 serves as a fastening point for a vertical suspension rope 26, via which the support elements 24 are suspended at a fitting 28, which is fastened at the ceiling, not shown in the figures.

In FIG. 2 the carrier 12 is shown in a first preferred embodiment. Accordingly, the two lateral arms 12a, 12b comprise rods, while the annular section 12c is formed by a closed, band-shaped body. As already discernible from FIG. 1, the annular section 12c of the carrier 12 shows a circular form. Here, the two lateral arms 12a, 12b are located diametrically opposite each other and project radially from the annular section 12c, which leads to the two arms 12a, 12b being located on a line forming the diameter of the annular section 12b and thus being aligned to each other.

The annular section 12c of the carrier 12 can be arranged pivotal about the arms 12a, 12b, so that in such a case the arms 12a, 12b are supported rotational at the annular section 12c of the carrier 12 so that, particularly in a stiff fastening of the lamp at the annular section 12c, the direction of illumination can be adjusted and installed by an appropriate pivoting of the annular section 12c, in this case serving as a frame, depending on the respective purpose for use and place of installation. Alternatively, the lateral arms 12a, 12b may also be fixed stiffly at the annular section 12c.

As further discernible from FIG. 2, fastening means 30 are provided at the arms 12a, 12b in order to fix the carrier 12 with its arms 12a, 12b at the rope sections and/or rope shafts 2a, 2b. In the exemplary embodiment shown the fastening means 30 comprise annular flaps or clamps, which ensure a secure fixation of the carrier 12 at the rope 2, however simultaneously they allow a rotational support for the lateral arms 12a, 12b, allowing a pivotal support of the annular section 12c about the arms 12a, 12b even in case of their stiff fastening at the annular section 12c.

In the embodiment shown in FIG. 2 a series of light diodes 14 is arranged in the circumferential direction at the interior of the annular section 12c. Due to the fact that the light diodes shown in FIG. 2 as well as the lamps shown in FIG. 1 represent lighting means, the light diodes in FIG. 2 are also marked with the reference character “14”. To this regards, the annular section 12c shows a plurality of serially arranged lights, although rather small ones. Alternatively, the annular section 12c and the light diodes fastened thereat can be understood jointly as a unit forming a lamp.

As further discernible from FIG. 2, two diametrically opposite sheaths 32 are provided at the circumference of the annular section 12c of the carrier 12, which project radially from the annular section 12c and respectively accept one end of an electric supply line 16. This way the electric supply lines 16 are mechanically fixed at the annular section 12c of a carrier 12, with additional measures, such as adhesion or clamping, here preventing any unintentional slipping out of the sheaths 32.

As further discernible from FIG. 2, the arms 12a, 12b and the sheaths 32 are arranged at an angular distance of 90° in reference to each other. When as in the exemplary embodiment shown the carrier 12 with its lateral arms 12a, 12b rests approximately perpendicular in reference to the longitudinal extension of the rope sections and/or rope shafts 2a, 2b, the sheaths 32 extend in the direction of the longitudinal extension of the rope sections and/or rope shafts 2a, 2b, which takes into consideration that in the exemplary embodiment shown the electric supply lines 16 extend approximately in the middle between the two rope sections and/or rope shafts 2a, 2b and parallel in reference thereto.

In the exemplary embodiment shown the sheaths 32 form simple fastening elements for the mechanic fastening of the electric supply lines 16, while the connection to the light diodes 14 occurs with the help of freely suspended or ‘over-hung’ connection cables 18.

1. A fastening device for at least one lighting means, comprising at least one rope and at least one carrier embodied for fastening at least one lighting means, comprising at least one fastening means for fastening at the ropes, and connection means for connecting at least one lighting means to at least one electric supply line, wherein at least one rope comprises at least one ultra-strong fiber or is made from at least one ultra-strong fiber.

2. A device according to claim 1, wherein at least one ultra-strong fiber is made from glass, carbon, aramid, or high strength polyethylene, particularly highly crystalline, highly stretched, macromolecular polyethylene.

3. A device according to claim 1, wherein at least one rope is embodied such that essentially the entire load is compensated by at least one carrier.

4. A device according to claim 1, further comprising at least two ropes that can be arranged distanced from each other, with at least one carrier showing at least two fastening means, distanced from each other, for fastening at the ropes.

5. A device according to claim 4, wherein the carrier shows at least two arms, which are provided respectively with a fastening means or form a fastening means.

6. A device according to claim 5, wherein the arms are arranged approximately aligned to each other.

7. A device according to claim 5, wherein the carrier with the arms can be arranged essentially perpendicular in reference to the longitudinal extension of the ropes.

8. A device according to claim 5, wherein the carrier shows an annular section, which is provided for fastening at least one lighting means.

9. A device according to claim 8, wherein the annular section is arranged between the arms.

10. A device according to claim 9, wherein the arms are arranged radially at the annular section.

11. A device according to claim 8, wherein the annular section is arranged pivotal about a pivotal axis, which is located approximately in a level stretched by an annular section.

12. A device according to claim 11, wherein the pivotal axis is aligned and/or coincides with at least one of the arms.

13. A device according to claim 8, wherein the carrier comprises bearing means, which are embodied for fastening at least one lamp inside the annular section.

14. A device according to claim 13, wherein the bearing means are embodied for the pivotal support of at least one lighting means about a pivotal axis, which is located approximately in a level stretched by the annular section.

15. A device according to claim 8, wherein the annular section comprises means for suspending at least one lighting means.

16. A device according to claim 15, wherein the means for suspension comprise two fittings arranged at the annular section, which are positioned approximately diametrically opposite each other are embodied for fastening at least one lighting means, carrying oblong, preferably rod or rope-shaped fastening elements.

17. A device according to claim 8, wherein a series of lighting means, preferably light diodes, is arranged along the annular section, preferably along its interior and/or exterior.

18. A device according to claim 8, wherein the carrier shows fastening means for fastening electric supply lines.

19. A device according to claim 18, wherein the fastening means are arranged at the annular section and are positioned approximately diametrically opposite each other.

20. A device according to claim 18, wherein the fastening means show sheaths, approximately radially projecting from the annular section, to accept one end of an electric supply line.

21. A lamp comprising:
a fastening device for at least one lighting means, comprising at least one rope and at least one carrier embodied for fastening at least one lighting means, comprising at least one fastening means for fastening at the ropes, and connection means for connecting at least one lighting means to at least one electric supply line, wherein at least one rope comprises at least one ultra-strong fiber or is made from at least one ultra-strong fiber.
